(19) United States
(12) Patent Application Publication
(10) Pub. No.: US 2004/0133703 A1
(43) Pub. Date: Jul. 8, 2004

(54) Network with sub-network which can be interconnected through bridge terminals

(76) Inventor: Joerg Habetha, Aachen (DE)

Correspondence Address: US Philips Corporation, Intellectual Property Department, P O Box 3001, Briarcliff Manor, NY, 10510, US

(21) Appl. No.: 10/476,709

(22) PCT Filed: May 8, 2002
(86) PCT No.: PCT/IB02/01505

(30) Foreign Application Priority Data
May 7, 2001 (DE) 101 22 044.8

(51) Int. Cl. G06F 15/16; H04L 12/28

(52) U.S. Cl. 709/249; 370/401; 709/228

(57) ABSTRACT

The invention relates to a network with several sub-networks which each comprise a controller for controlling a sub-network and which can each be connected via bridge terminals. A bridge terminal is set up, modified during operation, and released again by means of an exchange of messages of the relevant controller with the bridge terminal. The setup and modification procedures lay down the start moments and the durations of the presence of the bridge terminal in the sub-networks.

The invention relates to a network with a plurality of sub-networks which can be interconnected by means of respective bridge terminals and which each comprise a controller for controlling a sub-network. Such networks are self-organizing and may consist, for example, of several sub-networks. They are also denoted adhoc networks.

An adhoc network with several terminals is known from the documents “J. Habetha, A.Hettich, J. Peetz, Y. Du: Central Controller Handover Procedure for ETSI-BRAN HIPERLAN/2 Ad Hoc Networks and Clustering with Quality of Service Gurantees, 1st IEEE Annual Workshop on Mobile Ad Hoc Networking & Computing, Aug. 11, 2000” and “J. Habetha, M. Nadler: Concept of a Centralised Multihop Ad Hoc Network, European Wireless, Dresden, September, 2000”. At least one terminal is provided as a controller for controlling the adhoc network. It may be required under certain conditions that a different terminal becomes the controller. The subdivision into sub-networks is necessary once such a network reaches a certain size. Terminals constructed as bridge terminals serve to communicate with the sub-networks. These bridge terminals are synchronized with the sub-networks in alternation. Waiting times arise owing to different MAC frame structures of the connected networks until a bridge terminal can exchange data with the newly synchronized network.

The invention has for its object to provide a network which renders possible an improved data exchange between the sub-networks.

The invention also relates to a controller of a sub-network which can be connected to other sub-networks of a network via bridge terminals, and to a relevant method.

As for the network according to the invention, this object is achieved by means of a network with several sub-networks which each comprise a controller for controlling a sub-network and which can each be connected via bridge terminals, wherein a data communication between the sub-networks involved in the connection and the bridge terminal is provided for setting up a connection between sub-networks, and wherein this data communication is designed for laying down the temporal parameters of the presence of the bridge terminal in the sub-networks taking part in the connection.

According to the invention, a bridge terminal which is to interconnect two sub-networks should first be set up. To set up the connection between the sub-networks, the bridge terminal and the controllers of the sub-networks involved communicate with one another. The controllers involved here agree on the temporal parameters regarding the presence of the bridge terminal in the respective sub-networks. This means that it is laid down at what times the bridge terminal is present in the respective network taking part in the connection.

The word “presence” relating to a bridge terminal is understood to mean that the bridge terminal is synchronized with the respective sub-network and is available for a data exchange with the sub-network.

Since the temporal parameters of the presence of the bridge terminal in the sub-networks involved is laid down, the controllers know beforehand at what moments the bridge terminals will be present in the respective sub-network and can be used by the respective sub-network. The controller can thus efficiently plan and carry out the data transmission between the individual sub-networks and optimally utilize the transmission capacity of a bridge terminal.

The controllers of a sub-network are responsible for control and management functions. In addition, the controller can also operate as a normal terminal in the associated sub-network. The controller is responsible, for example, for the registration of terminals carrying out the operation in the sub-network, for establishing the connection between at least two terminals in the radio transmission medium, for the resource management, and for the access control in the radio transmission medium. Thus, for example, a terminal of a sub-network is assigned transmission capacity for data (packet units) by the controller after registration and after a transmission request was submitted.

In the network, the data may be exchanged between the terminals by a TDMA, FDMA, or CDMA method (TDMA=Time Division Multiplex Access, FDMA=Frequency Division Multiplex Access, CDMA=Code Division Multiplex Access). The methods may also be combined. A number of distinct channels is assigned to each sub-network of the network, which are denoted the channel group. A channel is defined by a frequency range, a time range, and, for example, in the CDMA method, a spreading code. For example, a certain, distinct frequency range with a distinct respective carrier frequency fᵢ may be available to each sub-network for the exchange of data. In such a frequency range, for example, data may be transmitted by the TDMA method. A first carrier frequency may then be assigned to the first sub-network, a second carrier frequency to a second sub-network, and a third carrier frequency to a third sub-network.

A bridge terminal, for example arranged between the first and the second sub-network, operates on the one hand for enabling a data exchange with the other terminals of the first network, at the first carrier frequency, and on the other hand for enabling a data exchange with the other terminals of the second sub-network, at the second carrier frequency.

To switch over between the various sub-networks, a synchronization of the bridge terminal with the new frequency must be achieved each time in this example. Synchronization is understood to denote the entire process of including a bridge terminal in the sub-network up to the moment the actual exchange of data starts.

Once the bridge terminal has been synchronized with a sub-network, it can exchange data with all terminals and with the controller of this sub-network.

The time frames of two sub-networks are usually not synchronized. A bridge terminal is accordingly not connected to a sub-network, not only during a switch-over time, but also during a waiting time.

The switch-over time is that time which is necessary for the bridge terminal to synchronize itself with the frequency of the new sub-network. The waiting time denotes the period between the end of the frequency synchronization with the new sub-network and the start of a new time frame of this sub-network.

The setup procedure of a bridge terminal may be initiated both by a controller and by the bridge terminal itself.

According to the invention, the controllers know from the laid down temporal parameters on the presence at what moments the bridge terminal is present in the respective sub-networks. This renders it possible for the controllers to take into account also the necessary switch-over times and waiting times in their planning and implementation of the data transmission between the individual sub-networks. The switch-over times and waiting times can be utilized by the controllers for serving the connections within a sub-network.

According to claim 2, the temporal parameters are preferably the respective duration of presence and duration of absence of the bridge terminal in the sub-networks taking part in the connection.

The duration of presence is understood to be that time period during which the bridge terminal can exchange data with the sub-network.

The duration of absence is understood to be that time period during which no data exchange between the bridge terminal and the sub-network is possible. The duration of absence thus comprises both the time period in which the bridge terminal is synchronized with another sub-network and the required switch-over and waiting times. The durations of presence and absence together form a full cycle. A further temporal parameter which is laid down is preferably the start moment of the full cycle. The start moment indicates the temporal position of the full cycle with respect to the time frame or clock of the respective sub-network. The controller of the respective sub-network knows from this when the full cycle, consisting of the duration of presence and the duration of absence, starts in the network.

In the advantageous embodiment of the invention as defined in claim 3, the temporal parameters of the presence of the bridge terminal are chosen in dependence on the nature of the data to be transmitted. Thus it is advantageous to choose the duration of presence of the bridge terminal in the two sub-networks involved to be comparatively short in the case of data which should be transmitted as quickly as possible without long delay times between two sub-networks. This means that switching-over takes place at comparatively short intervals between the two sub-networks. An example of such data with stringent requirements as regards the delay is formed by, for example, video data.

On the other hand, it is advantageous for data for which as high as possible a throughput is desired to provide a comparatively long duration of presence of the bridge terminal in the two sub-networks. This means that switching-over takes place at comparatively wide time intervals between the two sub-networks. Such data with high requirements as to the throughputs are, for example, database data.

In the advantageous embodiment of the invention as defined in claim 10, the data connections set up can be utilized by higher layers for the transmission of control information during the operation of the bridge terminal.

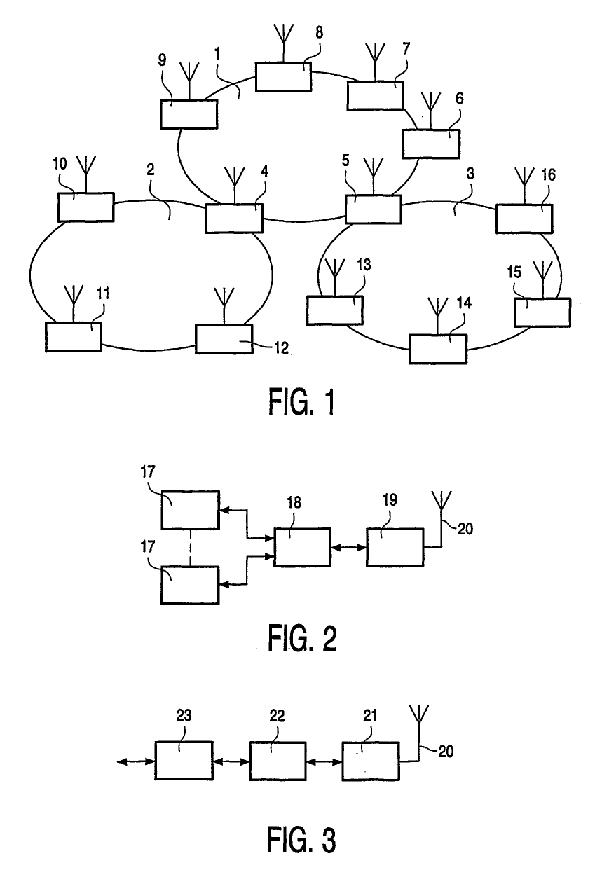

A few embodiments of the invention will be explained in more detail below with reference to the drawing comprising FIGS. 1 to 10, in which:

FIG. 1 shows an adhoc network with three sub-networks which each comprise terminals provided for radio transmission,

FIG. 2 shows a terminal of the local network of FIG. 1,

FIG. 3 shows a radio device of the terminal of FIG. 2,

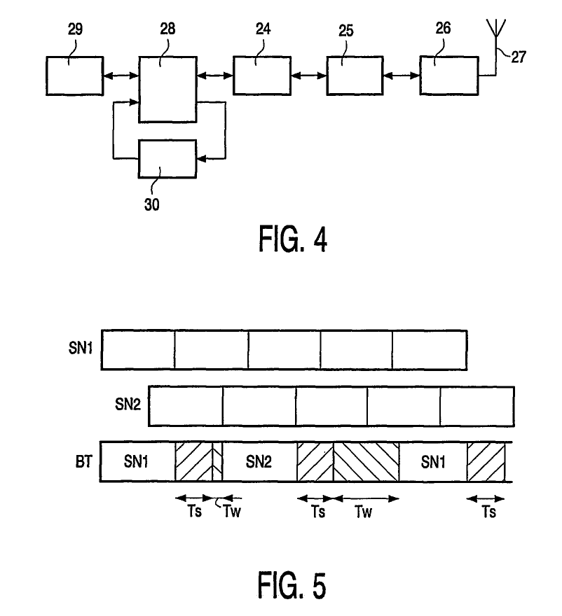

FIG. 4 shows an embodiment of a bridge terminal designed for interconnecting two sub-networks,

FIG. 5 shows MAC frames of two sub-networks and the MAC frame structure of a bridge terminal,

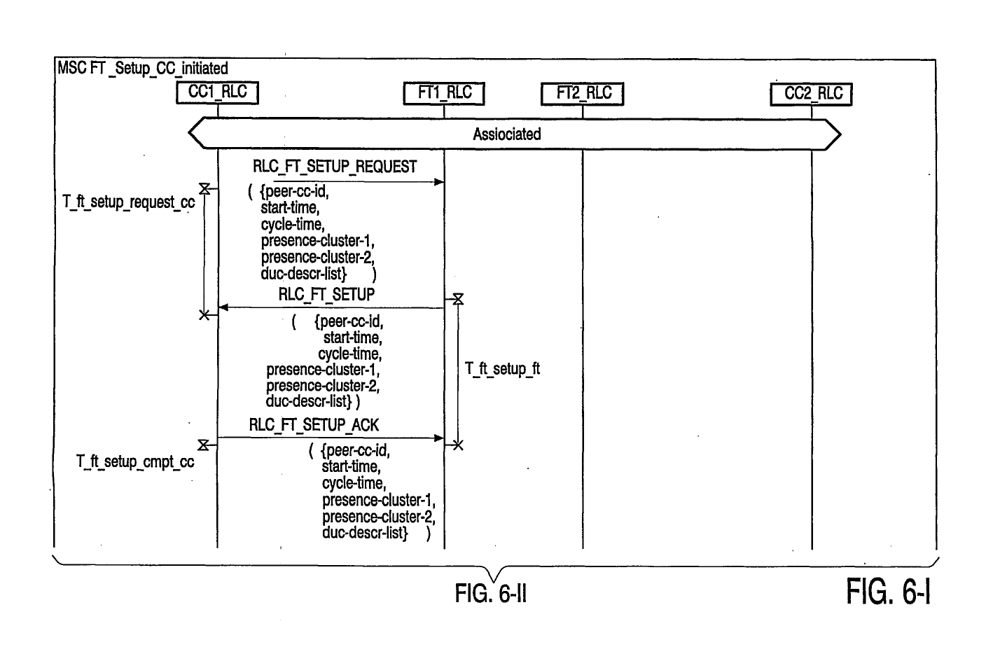

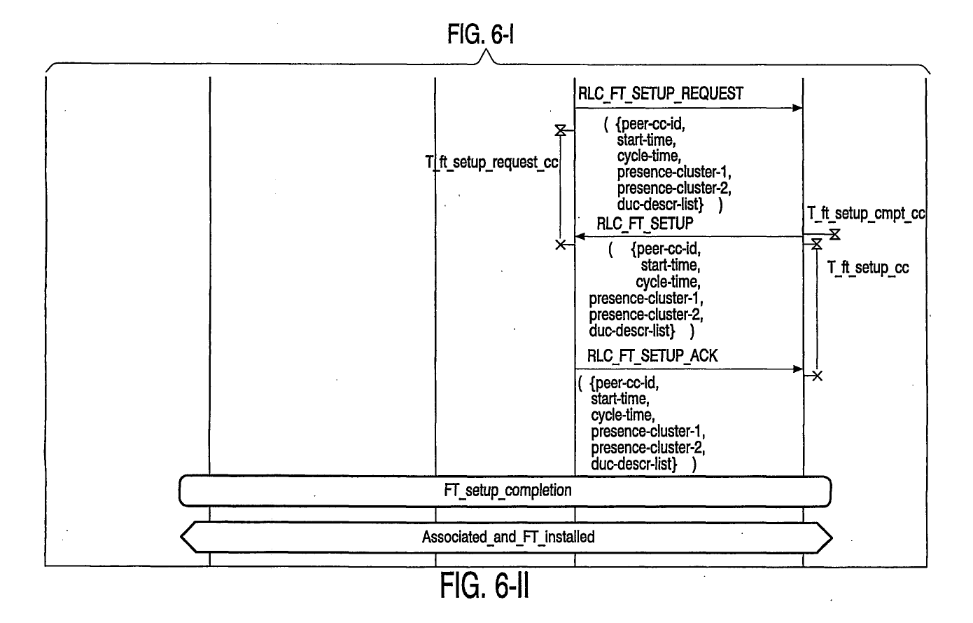

FIG. 6 shows a message sequence chart (MSC) of a setup procedure of a bridge terminal,

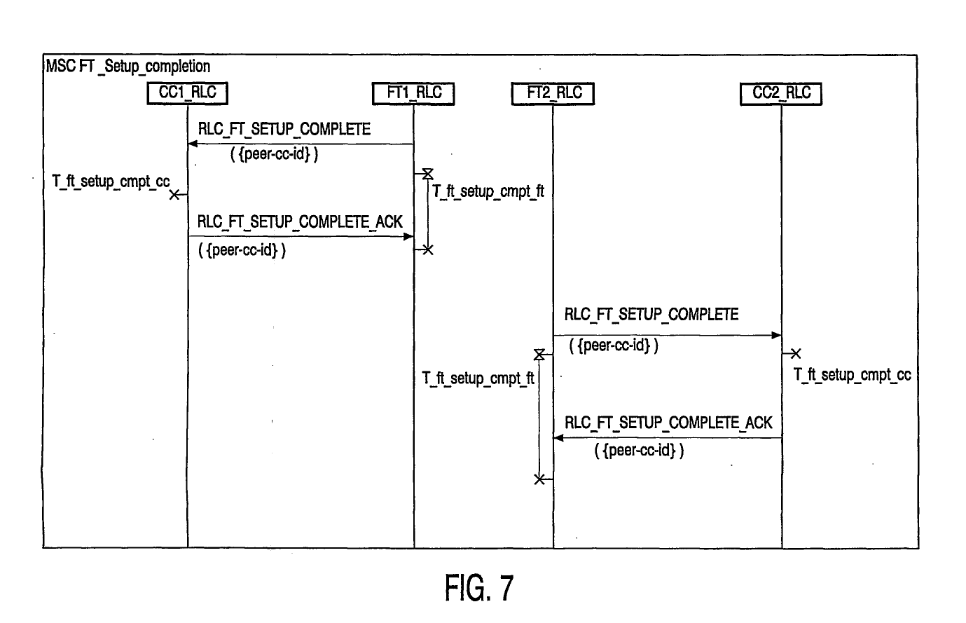

FIG. 7 shows a message sequence chart (MSC) of a setup completion procedure of a bridge terminal,

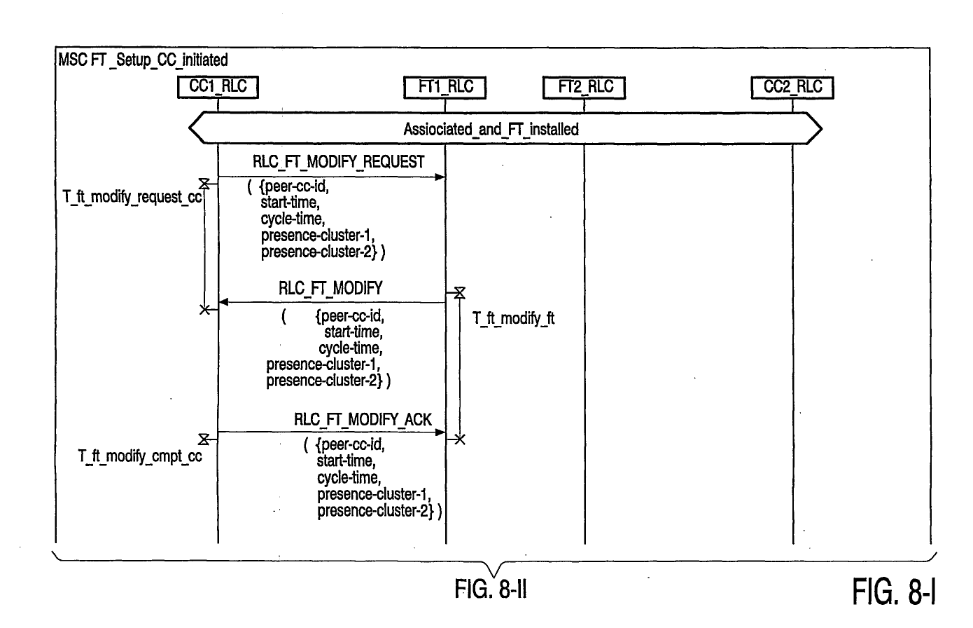

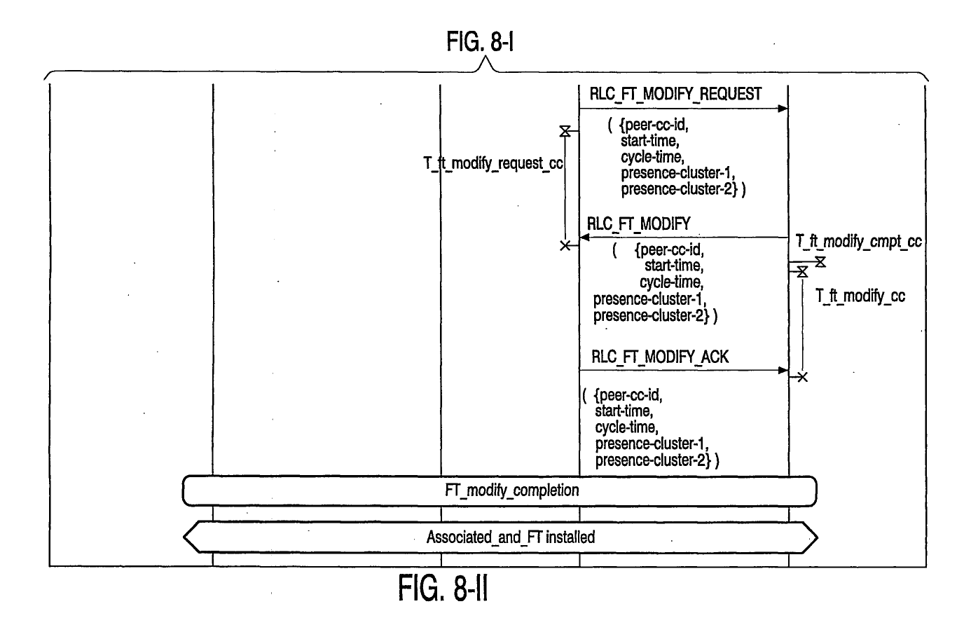

FIG. 8 shows a message sequence chart (MSC) of a modification procedure for a bridge terminal,

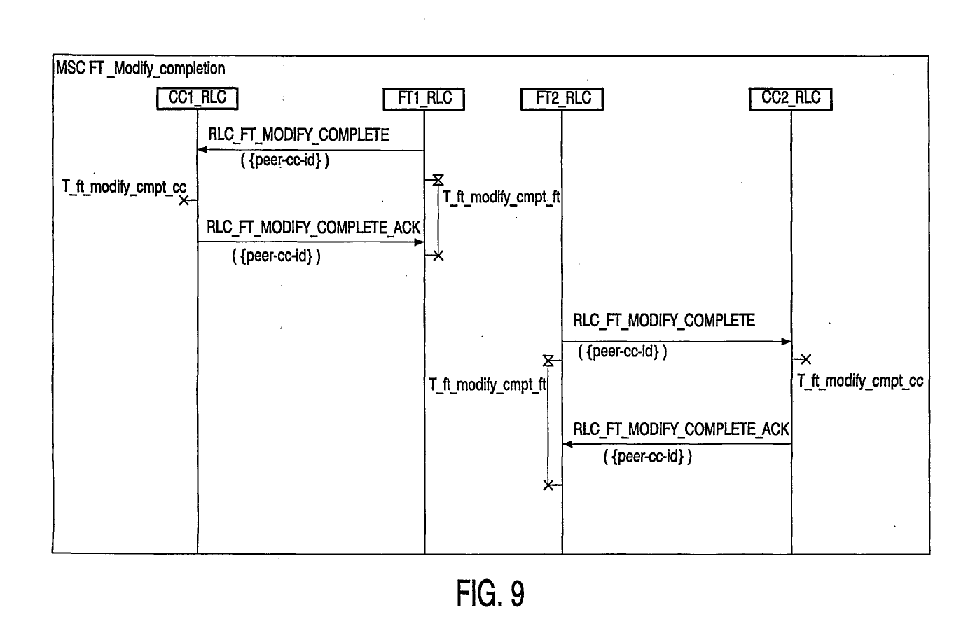

FIG. 9 shows a message sequence chart (MSC) of a modification conclusion procedure of a bridge terminal, and

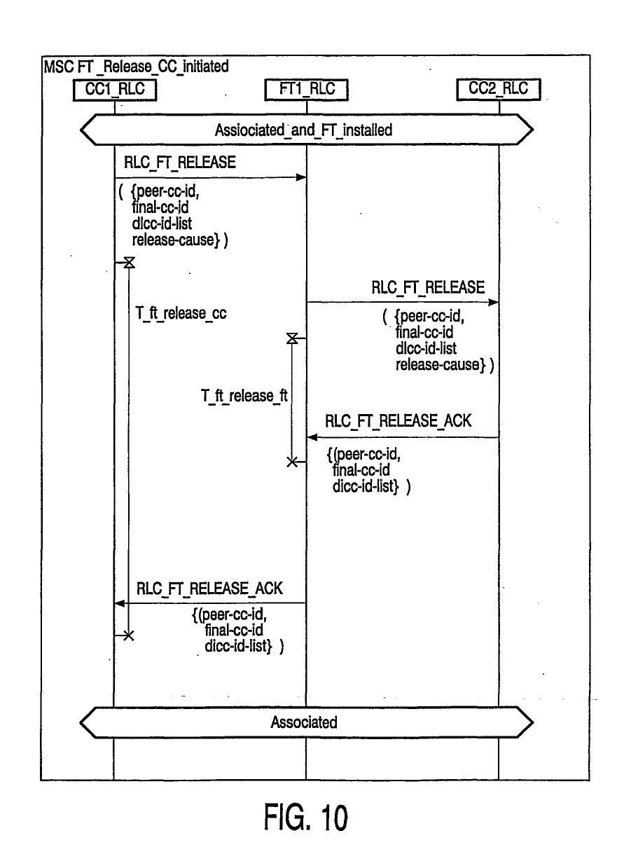

FIG. 10 shows a message sequence chart (MSC) of a release procedure of a bridge terminal.

The embodiment described below relates to adhoc networks which are self-organizing, in contrast to traditional networks. Each terminal in such an adhoc network can obtain access to a fixed network and is immediately employable. An adhoc network has the characteristic that the structure and number of participants is not laid down within given limit values. For example, a communication device of a participant may be taken from the network or may be included therein. An adhoc network is not dependent on a fixedly installed infrastructure, unlike traditional mobile telephone networks.

The area of coverage of the adhoc network is usually much larger than the transmission range of one terminal. A communication between two terminals may accordingly render it necessary to activate further terminals so that the latter can pass on messages or data between the two communicating terminals. Such adhoc networks, in which a transfer of messages and data via a terminal is necessary, are denoted multihop adhoc networks. A possible organization of an adhoc network consists in that sub-networks or clusters are regularly formed. A sub-network of the adhoc network may be formed, for example, by terminals interconnected by means of radio links and belonging to participants sitting around a table. Such terminals may be, for example, communication devices for the wireless exchange of documents, pictures, etc.

Two types of adhoc networks may be distinguished. They are decentralized and centralized adhoc networks. In a decentralized adhoc network, the communication between the terminals is decentralized, i.e. each terminal can communicate directly with any other terminal under the condition that the terminals lie within the transmission range of the respective other terminal. The advantage of a decentralized adhoc network is its simplicity and robustness against errors. In a centralized adhoc network, certain functions such as, for example, the function of multiple access of a terminal to the radio transmission medium (Medium Access Control=MAC) is controlled by a certain terminal for each sub-network. This terminal is denoted the central terminal or central controller (CC). These functions need not always be carried out by the same terminal, but they may be transferred from one terminal acting as the central controller to another terminal, which will then act as the central controller. The advantage of a central adhoc network is that an agreement on the quality of service (QoS) is possible therein in a simple manner. An example of a centralized adhoc network is a network organized in accordance with the HIPERLAN/2 Home Environment Extension (HEE) (cf. J. Habetha, A.Hettich, J. Peetz, Y. Du, “Central Controller Handover Procedure for ETSI-BRAN HIPERLAN/2 Ad Hoc Networks and Clustering with Quality of Service Gurantees”, 1^{st} IEEE Annual Workshop on Mobile Ad Hoc Networking & Computing Aug. 11, 2000).

FIG. 1 shows an embodiment of an adhoc network with three sub-networks 1 to 3, each comprising several terminals 4 to 16. The terminals 4 to 9 form part of the sub-network 1, the terminals 4 and 10 to 12 of the sub-network 2, and the terminals 5 and 13, to 16 of the sub-network 3. The terminals belonging to a sub-network exchange data through radio links in the respective sub-network. The ellipses drawn in FIG. 1 indicate the radio ranges of the respective sub-networks (1 to 3), in which a substantially unproblematic radio transmission is possible between the terminals belonging to the sub-network.

The terminals 4 and 5 are denoted bridge terminals, because they render possible an exchange of data between two sub-networks 1 and 2 and between 1 and 3, respectively. The bridge terminal 4 is responsible for the data traffic between the sub-networks 1 and 2, and the bridge terminal 5 for the data traffic between the sub-networks 1 and 3.

A terminal 4 to 16 of the local network of FIG. 1 may be a mobile or a fixed communication device and comprises, for example, at least a station 17, a connection control device 18, and a radio device 19 with an antenna 20, as shown in FIG. 2. A station 17 may be, for example, a laptop computer, a telephone, etc.

A radio device 19 of the terminals 6 to 16 comprises not only the antenna 20, but also, as shown in FIG. 3, a high-frequency circuit 21, a modem 22, and a protocol device 23. The protocol device 23 forms packet units from the data flow received from the connection control device 18. A packet unit contains parts of the data flow and additional control information formed by the protocol device 23. The protocol device uses protocols for the LLC layer (LLC=Logical Link Control) and the MAC layer (MAC=Medium Access Control). The MAC layer controls the multiple access of a terminal to the radio transmission medium, and the LLC layer carries out a data flow and error check.

As was noted above, a certain terminal is responsible for the control and management functions and is denoted the central controller in a sub-network 1 to 3 of a centralized adhoc network. The controller in addition acts as a normal terminal in the relevant sub-network. The controller is responsible, for example, for the registration of terminals which come into operation in the sub-network, for the establishment of lins between at least two terminals in the radio transmission medium, for the resource management, and for the access control in the radio transmission medium. Thus, for example, one terminal of a sub-network is allocated a transmission capacity for data (packet units) by the controller after registration and after a transmission request has been made.

The data can be exchanged between the terminals in the adhoc network by a TDMA, FDMA, or CDMA method (TDMA=Time Division Multiplex Access, FDMA=Frequency Division Multiplex Access, CDMA=Code Division Multiplex Access). The methods may also be combined. Each sub-network 1 to 3 of the local network is allocated a number of given channels, which are denoted a channel group. A channel is defined by a frequency range, a time range, and, for example in the CDMA method, a spreading code. For example, a certain, always unique frequency range with a carrier frequency f₁ may be available to each sub-network 1 to 3 for data exchange. In such a frequency range, for example, data may be transmitted by the TDMA method. The carrier frequency f₁ may then be allocated to the sub-network 1, the carrier frequency f₂ to the sub-network 2, and the carrier frequency f₃ to the sub-network 3. The bridge terminal 4 operates on the one hand for enabling a data exchange with the other terminals of the sub-network 1 with the carrier frequency f₁, and on the other hand for enabling a data exchange with the other terminals of the sub-network 2 with the carrier frequency f₂. The second bridge terminal 5 present in the local network, which transmits data between the sub-networks 1 and 3, operates with the carrier frequencies f₁ and f₃.

As was noted above, the central controller has the function, for example, of access control. This means that the central controller is responsible for forming frames of the MAC layer (MAC frames). The TDMA method is used here. Such an MAC frame comprises several channels for control information and payload data.

A block diagram of an embodiment of a bridge terminal is shown in FIG. 4. The radio switching device of this bridge terminal comprises a protocol device 24, a modem 25, and a high-frequency circuit 26 with an antenna 27. A radio switching device 28 is connected to the protocol device 24 and is further connected to a connection control device 29 and an intermediate storage device 30. The intermediate storage device 30 in this embodiment comprises a memory element, serves for the intermediate storage of data, and is realized as a FIFO component (First In First Out), i.e. the data are read out from the intermediate storage device 30 in the sequence in which they were written into it. The terminal shown in FIG. 4 is also capable of operating as a normal terminal. Stations connected to the connection control device 29 and not shown in FIG. 4 in that case supply data to the radio switching device 28 via the connection control device 29.

The bridge terminal of FIG. 4 is synchronized alternately with a first and with a second sub-network. Synchronization is understood to mean the entire process of incorporation of a terminal in the sub-network up to the exchange of data. When the bridge terminal is synchronized with the first sub-network, it can exchange data with all terminals and with the controller of this first sub-network. When data are supplied by the connection control device 29 to the radio switching device 28, whose destination is a terminal or the controller of the first sub-network or a terminal or controller of another sub-network which can be reached via the first sub-network, the radio switching device will pass these data on directly to the protocol device 24. The data are put into intermediate storage in the protocol device 24 until the time period determined by the controller for the transmission has been reached. When the data given out by the connection control device 29 are to be sent to a terminal or to the controller of the second sub-network, or to some other sub-network accessible via the second sub-network, the radio transmission is to be delayed up to the time period in which the bridge terminal is synchronized with the second sub-network. The radio switching device accordingly directs those data whose destination lies in the second sub-network or whose destination is accessible via the second sub-network towards the intermediate storage device 30, which stores the data until the bridge terminal is synchronized with the second sub-network.

When data are received by the bridge terminal from a terminal or from the controller of the first sub-network, and the destination thereof is a terminal or the controller of the second sub-network or a terminal or controller of a different sub-network accessible via the second sub-network, these data are also put into storage in the intermediate storage device 30 until the synchronization with the second sub-network is achieved. Data whose destination is a station of the bridge terminal are directly passed through the radio switching device 28 to the connection control device 29, which then passes on the received data to the desired station. Data whose destination is neither a station of the bridge terminal nor a terminal or controller of the second sub-network are sent, for example, to a further bridge terminal.

After the synchronization switch of the bridge terminal from the first to the second sub-network, the data present in the intermediate storage device 30 are read out from the intermediate storage device 30 again in the writing sequence. Then all data whose destination is a terminal or the controller of the second sub-network or some other sub-network accessible via the second sub-network can be passed on immediately to the protocol device 24 by the radio switching device 28 in the time period of synchronization of the bridge terminal with the second sub-network, and only those data whose destination is a terminal or the controller of the first sub-network or some other sub-network accessible via the first sub-network are stored in the intermediate storage device 30.

The MAC frames of two sub-networks SN1 and SN2 are usually not synchronized. Accordingly, a bridge terminal BT is not connected to a sub-network SN1 or SN2, not only during a switch-over time Ts but also during a waiting time Tw. This can be seen in FIG. 5, which shows a sequence of MAC frames of the sub-networks SN1 and SN2 as well as the MAC frame structure of the bridge terminal BT. The switch-over time Ts is that time which is necessary for the bridge terminal to synchronize with a sub-network. The waiting time Tw is the time between the end of the synchronization with the sub-network and the start of a new MAC frame of this sub-network.

Assuming that the bridge terminal BT is connected to a sub-network SN1 or SN2 only for the duration of one MAC frame each time, the bridge terminal BT will only have a channel capacity of ¼ of the available channel capacity of a sub-network. In the other extreme case, in which the bridge terminal BT is connected to a sub-network for a comparatively long period, the channel capacity is half the available channel capacity of a sub-network.

A bridge terminal setup procedure is used according to the invention for optimally utilizing the transmission capacity of a bridge terminal and for rendering it possible to plan the durations of presence of this terminal in the clusters from the point of view of the controller. During this setup procedure, the durations of presence of the bridge terminal in the clusters and the start moments of these durations of presence are negotiated between the bridge terminal and the controllers of the sub-networks involved. The main advantage of the method is the predictability of the presence of the bridge terminal in a cluster from the point of view of the central controller of this cluster, which can accordingly utilize this information for an optimized capacity allocation (“scheduling”) of the MAC frame.

The setup procedure may be initiated both by a controller and by the bridge terminal itself. FIG. 6 shows a possible embodiment of a setup procedure as a so-called message sequence chart (MS C). The bridge terminal is here denoted the “forwarding terminal”, FT for short. The setup procedure is denoted “FT-SETUP”. FIG. 6 shows the case of a connection between two sub-networks, where the FT-SETUP procedure is initiated by one of the two controllers (CC). This CC sends a RLC_FT_SETUP_REQUEST message to the FT for setting up the terminal as the FT between the requesting CC and the CC with the identification number “peer-cc-id”. Suggestions for a start moment of the sub-network switch-over phases, for the periods of a presence and absence cycle (“cycle time”), and for the duration of the presence of the FT in each sub-network (“presence-cluster-1” and “presence-cluster-2”) are made in the message. It could be implicitly laid down, for example, that the FT always starts in the sub-network of the requesting CC at the start moment (“cluster-1” in FIG. 6). The message RLC_FT_SETUP_REQUEST furthermore initiates the establishment of one or several data links between the first CC and the FT and between the FT and the second CC. These links (this link) may be utilized in the subsequent operation of the network layer, for example, for transmitting routing information. The parameters of the links to be established are contained in a duc-descr-list.

The FT replies to the RLC_FT_SETUP_REQUEST of the CC with a RLC_FT_SETUP message, in which the FT lays down definite values for the start moment, the cycle time, and the durations of presence in the sub-networks, as well as the parameters of the links to be built up. The RLC_FT_SETUP_ACK message only serves to provide an acknowledgement of the CCs of any parameter values which may have been changed by the FT (and may be regarded as optional).

A fully analogous procedure now runs between the FT and the CC of the target sub-network, with the difference that the request now originates from the FT. It also becomes clear here how the FT-SETUP procedure will be implemented in the case in which it is initiated by the FT itself from the start. In that case, the first exchange of messages would have started from the FT and would have resembled the exchange of messages of the FT with CC-2. It should be noted that the two units FT1_RLC and FT2_RLC from FIG. 6 are located in the same FT.

Subsequent to the FT-SETUP with the second CC, the two CCs must now be informed about the successful completion of the procedure with the respective partner CC. The exchange of messages FT-SETUP-COMPLETION serves this purpose as shown in detail in FIG. 7.

The FT informs both CC1 and CC2 by means of a FT_SETUP_COMPLETE message of the successful completion of the setup procedure. The two CCs in their turn acknowledge the reception of this message with a FT_SETUP_COMPLETE_ACK message.

In FIGS. 6 and 7, two diabolo symbols indicate the setting of a timer, and a cross the run-out of the respective timer. A timer has the purpose inter alia of triggering a suitable exceptional treatment if a respected reply signal is not given. It should further be noted that further information may be exchanged in addition to the parameters of the messages mentioned above.

The setup procedure lays down the durations of presence of the bridge terminals in the sub-networks to certain values. According to the invention, however, a modification procedure (FT_MODIFY) is used for nevertheless enabling an adaptation of the parameters of the data handling, such as, for example, the durations of presence in the sub-networks, to change requirements in a flexible manner.

The FT-MODIFY procedure can be initiated, like the SETUP procedure, both by one of the CCs and by the FT itself. FIG. 8 shows the FT-MODIFY procedure for the case in which initiation takes place by a CC. A clarification of the exchange of messages will not be given because it is fully analogous to the FT-SETUP procedure. At the end, a FT-MODIFY-COMPLETION exchange of messages is necessary, shown in FIG. 9, which proceeds in a manner analogous to the FT-SETUP-COMPLETION exchange of messages.

The parameters of the links of the FT thus set up may be modified independently of the cycle and durations of presence of the FT in a separate connection modification procedure.

Finally, it may be useful to free a bridge terminal of its tasks when a further connection by the relevant terminal is no longer necessary. For this purpose, according to the invention, a release procedure is used which is denoted FT-RELEASE.

This procedure, too, may be initiated by a CC as well as by the FT itself. FIG. 10 shows a possible embodiment of a release procedure in the form of a so-termed message sequence chart (MSC) for the CC-initiated case.

A CC notifies the FT of the desire to release by means of a RLC_FT_RELEASE message. The FT in its turn then sends a RLC_FT_RELEASE message to all further CCs involved (one further CC in the present example). These CCs reply with a RLC_FT_RELEASE_ACK message. It is not until such an acknowledgement has been received from all other CCs involved that the FT in its turn acknowledges to the initiating CC the termination of the through-connection activity by means of a RLC_FT_RELEASE_ACK message, whereupon said activity is instantly stopped.

If the FT-RELEASE is initiated by the FT itself, the first RLC_FT_RELEASE request of the CC is omitted. Instead, the FT itself sends RLC_FT_RELEASE messages to all CCs involved. The FT gives up its through-connection activities only after receiving a RLC_FT_RELEASE_ACK message from each individual CC.

It is apparent from FIG. 10 that the RLC_FT_RELEASE message may comprise further parameters such as, for example, “final-cc-id” and “release-cause” in addition to the Ids of the respective other CCs.

The parameter “final-cc-id” denotes the controller in whose sub-network the FT finally remains as a simple terminal. In the case of a CC-initiated FT-RELEASE, the indication of the final-cc-id in the first RLC_FT_RELEASE message is to be interpreted merely as a recommendation. It is the FT itself which decides in the final analysis in which sub-network it wants to remain, and it notifies the relevant controllers thereof in the messages RLC_FT_RELEASE and RLC_FT_RELEASE_ACK.

The parameter “release-cause” characterizes the grounds for the release of the FT.

Connections of the FT may be released (for example those utilized by the network layer) simultaneously with the release of the through-connection function. The parameter dlcc-id-list is a list of all connection identifiers which are released together with the relinquishing of the FT function.

1. A network with several sub-networks which each comprise a controller for controlling a sub-network and which can each be connected via bridge terminals, wherein a data communication between the sub-networks involved in the connection and the bridge terminal is provided for setting up a connection between sub-networks, and wherein this data communication is designed for laying down the temporal parameters of the presence of the bridge terminal in the sub-networks taking part in the connection.

2. A network as claimed in claim 1, characterized in that the temporal parameter of the presence of the bridge terminal are the respective duration of presence and duration of absence of the bridge terminal in the sub-networks involved in the connection as well as the respective start moment of a full cycle consisting of the duration of presence and the duration of absence.

3. A network as claimed in claim 1, characterized in that the temporal parameters of the presence of the bridge terminal are chosen in dependence on the nature of the data to be transmitted.

4. A network as claimed in claim 1, characterized in that a modification procedure is provided for bridge terminals which have been set up, and in that the modification procedure is designed for changing the temporal parameters of the presence of the bridge terminal in the sub-networks involved in the connection.

5. A network as claimed in claim 1, characterized in that a release procedure is provided for bridge terminals which have been set up, and in that the release procedure is designed for ending the connection of the involved sub-networks.

6. A network as claimed in claim 1, characterized in that the same duration of presence is provided for the sub-networks involved in the connection.

7. A network as claimed in claim 1, characterized in that a fixed transmission capacity is provided for the data to be transmitted between the sub-networks in the durations of presence of the bridge terminal in a sub-network.

8. A network as claimed in claim 7, characterized in that a higher transmission priority is provided for the data to be transmitted between the sub-networks in the durations of presence of the bridge terminal in a sub-network than for the data to be transmitted within the sub-network.

9. A network as claimed in claim 1, characterized in that at least two bridge terminals are provided for a connection between two sub-networks, and in that a data exchange is provided between the sub-networks involved in the connection and the bridge terminal for setting up this connection, which data exchange serves to lay down or coordinate the temporal parameters of the presence of the bridge terminal in the sub-networks involved in the connection.

10. A network as claimed in claim 1, characterized in that data links are setup and released during the setup procedure and the release procedure, respectively.

11. A method of controlling a network comprising several sub-networks which each comprise a controller for controlling a sub-network and which can each be connected via bridge terminals, wherein for setting up of a connection between sub-networks a data communication is provided between the sub-networks involved in the connection and the bridge terminal, and said data communication serves to lay down the temporal parameters of the presence of the bridge terminal in the sub-networks involved in the connection.

12. A controller for controlling a sub-network which can be connected to other sub-networks of a network via bridge terminals, wherein the controller, for setting up a connection between sub-networks, is designed for carrying out a data communication with the other sub-networks involved in the communication and the bridge terminal, and wherein said data communication serves to lay down the temporal parameters of the presence of the bridge terminal in the sub-networks involved in the connection.
